(19) United States
(12) Patent Application Publication
(10) Pub. No.: US 2016/0155254 A1
(43) Pub. Date: Jun. 2, 2016

(54) MOBILE DEVICE INTERFACE FOR COMPARING UNIQUE ITEMS CHARACTERIZED BY A LARGE NUMBER OF ATTRIBUTES

(71) Applicant: Blue Nile, Inc., Seattle, WA (US)

(72) Inventor: Scot Briscoe, Seattle, WA (US)

(21) Appl. No.: 14/955,745

(22) Filed: Dec. 1, 2015

Related U.S. Application Data
(60) Provisional application No. 62/086,395, filed on Dec. 2, 2014.

(51) Int. Cl. G06T 11/60; G06F 3/0485

(52) U.S. Cl. CPC G06T 11/60; G06F 3/0485

(57) ABSTRACT

A system and method for generating an interface to enable mobile device users to more easily compare unique items having multiple attributes are disclosed. The method can include receiving a dataset describing multiple unique items characterized by multiple attributes, determining a size and resolution of a display, and determining which unique items/attributes to be displayed on the display based on the size and resolution. The selected unique items and attributes are displayed in a grid which includes a fixed region designated by a user. A portion of the dataset is displayed in the fixed region. In response to a scrolling commend from the user, the method can selectively present additional portions of the dataset in the remainder of the grid that is not within the fixed region.

### CROSS-REFERENCE TO RELATED APPLICATION(S)

This application claims the benefit of U.S. Provisional Patent Application No. 62/086,395, entitled “MOBILE DEVICE INTERFACE FOR COMPARING UNIQUE ITEMS CHARACTERIZED BY A LARGE NUMBER OF ATTRIBUTES,” filed Dec. 2, 2014, which is incorporated herein by reference in its entirety.

### BACKGROUND

When purchase decisions involve unique items (e.g., gemstones, antiques, used cars, art, clothing, and so on) with a large number of attributes that characterize an item, potential purchasers may want to focus on certain attributes over others. For example, in the case of gemstones, consumers may be more interested in purchasing gemstones with particular cuts. In another example, consumers may consider the attributes of “color” and “clarity” to be more important than other attributes such as “size” or “price”. Because some attributes play more important roles than others when consumers make purchase decisions, it is often difficult to predict which attributes are the most important to a consumer when making such a decision.

Many unique items have a seemingly unlimited number of possible combinations of attributes. In order to provide a large number of purchase options to consumers, sellers of unique items often consolidate the items in large inventories or databases. For a consumer who uses a mobile device as a means for accessing these unique items for potential purchase, it is extremely difficult and at times impossible to present all the combinations of attributes to the consumer at one time. The difficulty in presenting items is due in part to limitations such as the small size and/or resolution of mobile device displays. To date, however, retailers have struggled to create an interface that easily allows combinations of attributes to be displayed to consumers using mobile devices in order to facilitate their purchase decisions of unique items.

### BRIEF DESCRIPTION OF THE DRAWINGS

FIG. 1 is a schematic block diagram of a mobile device in which an interface for comparing unique items may be generated.

FIG. 2 is a schematic block diagram illustrating a suitable environment in which the disclosed system may be implemented.

FIGS. 3A-3C are schematic diagrams illustrating a representative interface suitable for the efficient display of unique items having multiple attributes on a mobile device display.

FIG. 4 is a flowchart of a method for generating an interface for comparing unique items.

FIG. 5 is a schematic diagram illustrating a representative set of unique item data that might be received by the disclosed system.

FIGS. 6A-6D are schematic diagrams illustrating example fixed regions and scrolling regions of a displayed interface.

### DETAILED DESCRIPTION

A system and method for generating an interface to enable mobile device users to more easily compare unique items having multiple attributes are disclosed. The generated interface can help mobile device users make purchase decisions of unique items by effectively presenting, in a meaningful way, a way for a user to selectively view certain unique items or attributes of unique items. Preferably, the interface is presented in the form of a grid. The displayed grid has a two-dimensional structure, with one axis reflecting various unique items and the second axis representing various attributes of unique items. The disclosed system allows a mobile device user to select specific potions of the grid to remain fixed on their mobile device, while other portions can be scrolled. For example, a mobile device user can select certain attributes that they are most interested in when making a purchase decision (e.g., selecting an attribute “price” when purchasing gemstones) and keep those attributes fixed on the screen. The interface described herein is especially advantageous for the reason that typical mobile devices have limited display area, which therefore puts a premium on screen real estate when displaying large data sets.

The system may further allow mobile device users to define multiple fixed regions on a display, so as to constantly display or present selected data (e.g., data related to the most-relevant attributes) in the fixed region(s). The display area that has not been designated as “fixed” is set as a “scrolling” region. The system allows mobile device users to view other data by scrolling, rotating, or refreshing that data into the scrolling region. By doing so, the mobile device users can easily compare the fixed data with other data entries by scrolling, rotating, or refreshing the other data so that the fixed data and the desired other data is displayed on the same display simultaneously. Additional details regarding fixed regions and scrolling regions will be discussed herein.

In some embodiments, the grid of unique items is a set of search results generated by applying a search query against a dataset of unique items. One axis of the grid corresponds to the unique items satisfying the search query, and the second axis of the grid corresponds to the attributes for each of the identified unique items. In many circumstances, the portion of the grid that can be displayed on a mobile device display is significantly less than the entirety of the grid. As a result, the system determines which unique items to initially be presented on the displayed portion of the grid as well as which of the attributes should be displayed. The number of unique items to display as well as the number of attributes to display may be determined based on a size and a resolution of the corresponding device display. For example, to be visually recognizable for average viewers, the number of unique items cannot exceed 10 and the number of attributes cannot exceed 8 for a 5″×4″ display, assuming the resolution of the display is 1680×1050. It will be appreciated, of course, that the number of unique items and number of attributes that are displayed can vary widely based on, for example, size of screen display, resolution of screen display, device operator preferences (e.g., font size), portion of the screen display being used for other applications, etc.

The following description provides specific details for a thorough understanding and enabling description of these embodiments. One skilled in the art will understand, however, that the present technology can be practiced without many of these details. Additionally, some well-known structures or functions are not shown or described in detail, so as to avoid unnecessarily obscuring the relevant description of the various embodiments.

The terminology used in the description presented below is intended to be interpreted in its broadest reasonable manner, even though it is used in conjunction with a detailed description of certain specific embodiments of the present technology. Certain terms may even be emphasized below; however, any terminology intended to be interpreted in any restricted manner will be overtly and specifically defined as such in this Detailed Description section.

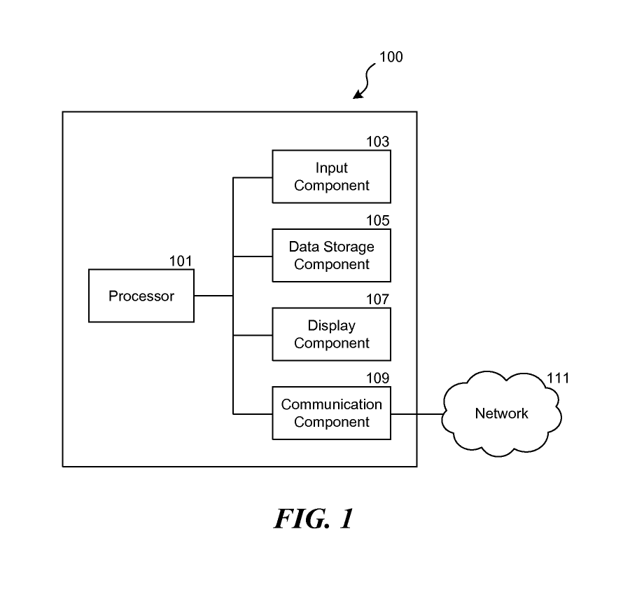

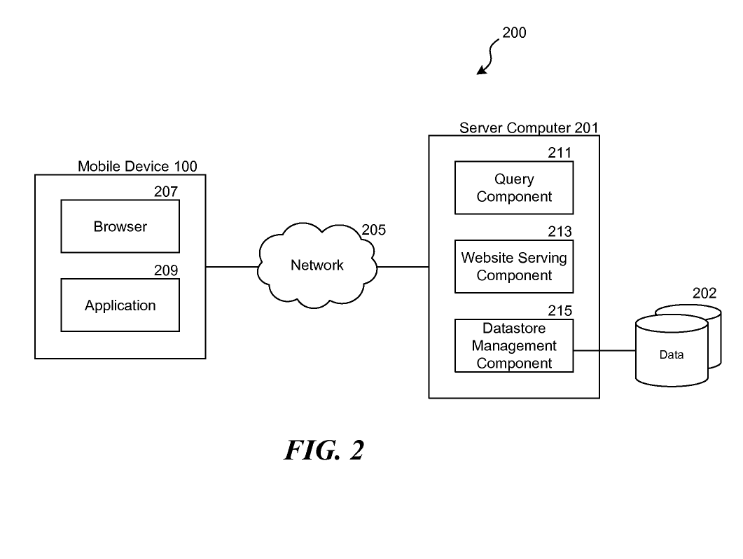

FIGS. 1 and 2 and the following discussion provide a brief, general description of suitable computing environments in which aspects of the present technology can be implemented. Although not required, aspects and embodiments of the present technology will be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, mini-computers, mainframe computers, and the like. The present technology can be embodied in a special purpose computer or data processor that is specifically programmed, configured, or constructed to perform one or more of the computer-executable instructions explained in detail below. In some embodiments, the disclosed functionality may be implemented by instructions encoded in a non-transitory computer-readable storage medium.

The present technology can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the present technology described below can be stored or distributed on computer-readable media, including magnetic and optically readable and removable computer discs, stored as firmware in chips (e.g., Electrically-Erasable Programmable Read-Only Memory chips, EEPROM chips), as well as distributed electronically over the Internet or over other networks (including wireless networks). Those skilled in the relevant art will recognize that portions of the present technology can reside on a server computer, while corresponding portions reside on a mobile device. Data structures and transmission of data particular to aspects of the present technology are also encompassed within the scope of the present technology.

FIG. 1 is a schematic block diagram illustrating components of a mobile device 100, such as a smartphone, tablet computer, phablet, laptop, wearable computer, etc., in which the interface for comparing unique items may be generated. As shown in FIG. 1, the mobile device 100 includes a processor 101, an input component 103, a data storage component 105, a display component 107, and a communication component 109. The processor 101 is configured to couple with and control other components in the mobile device 100. The mobile device 100 can communicate with other systems (e.g., Web servers or other devices) through the communication component 109 via a network 111. In some embodiments, the mobile device 100 can communicate with an output device (e.g., printers, speakers, tactile output devices, etc.) through the communication component 109. Network 111 can be any private or public network, such as the Internet, a corporate intranet, a wireless communication network, or a wired communication network.

The input component 103 is configured to receive an input (e.g., an instruction or a command) from a mobile device user. The input component 103 can include a keyboard, a touch pad, a touchscreen, a microphone, a joystick, a pen, a game pad, a scanner, a camera, and/or the like. The data storage component 105 can include any type of computer-readable media that can store data accessible to the processor 101. In some embodiments, the data storage component 105 can include random-access memories (RAMs), read-only memories (ROMs), flash memory cards, magnetic hard drives, optical disc drives, digital video discs (DVDs), cartridges, smart cards, etc.

The display component 107 is configured to display information to the mobile device user. In some embodiments, the display component 107 can include flat panel displays such as liquid crystal displays (LCDs), light emission diode (LED) displays, plasma display panels (PDPs), electro-luminescence displays (ELDs), vacuum fluorescence displays (VPDs), field emission displays (FEDs), organic light emission diode (OLED) displays, surface conduction electron emitter displays (SEDs), or carbon nano-tube (CNT) displays.

FIG. 2 is a schematic block diagram of an environment 200 in which the system for generating an interface for comparing unique items may operate. The environment 200 can include one or more server computers 201 that access data stores 202 containing information on a plurality of unique items. The server computers 201 communicate with mobile devices 100 via a network 205. The mobile devices 100 may send search queries to the server computers 201 pertaining to unique items. The search queries are processed by the server computers 201 against the data in the data stores 202. The server computers 201 may retrieve, analyze, and format (e.g., in a format of a grid) unique item information that is responsive to the received search queries. The server computer 201 transmits data responsive to the search queries to a requesting mobile device 100 through the network 205. The network 205 can include the Internet, an intranet, a wireless communication, or a wired communication.

The server computer 201 includes a query processing component 211, a website serving component 213, and a database management component 215. The query component 211 is configured to perform query processing and analysis. The website management component 213 is configured to handle creation, display and/or routing of suitable information in the form of web pages. The database management component 215 is configured to manage access to and maintenance of data stores 202. The server computer 201 can employ security measures (e.g., firewall systems, secure socket layers (SSL), password protection schemes, encryption, and/or the like) to inhibit malicious attacks and to preserve integrity of the information stored in the data stores 202.

The mobile device 100 may include one or more programs that submit queries to the server computers and receive responsive results. For example, a browser component 207 is configured to access and exchange data with the server computer 201 through the network 205. Results of data queries are displayed in a browser application (e.g., Firefox, Chrome, Internet Explorer, Safari, etc.) of the mobile device 100 for review by the mobile device user. As another example, an application component 209 is configured to display or present received information to a mobile device user via a dedicated application. Data may be received from the server computer 201 via an application programming interface (API), and the received data formatted for display by the application on the mobile device 100. The server computer 201 and the mobile device 100 can include other programs or modules such as an operating system, one or more application programs (e.g., word processing or spread sheet applications), and the like.

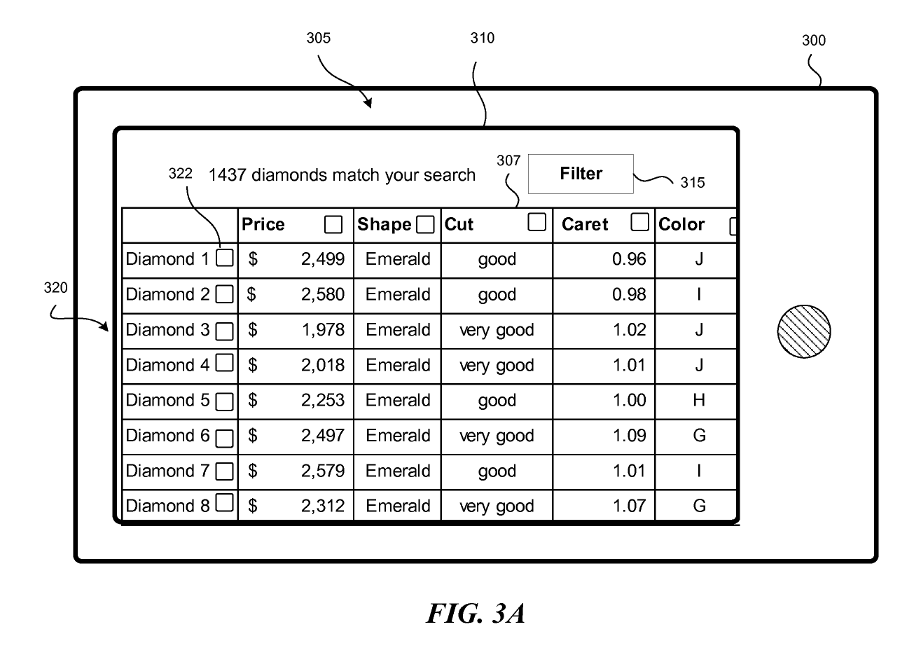

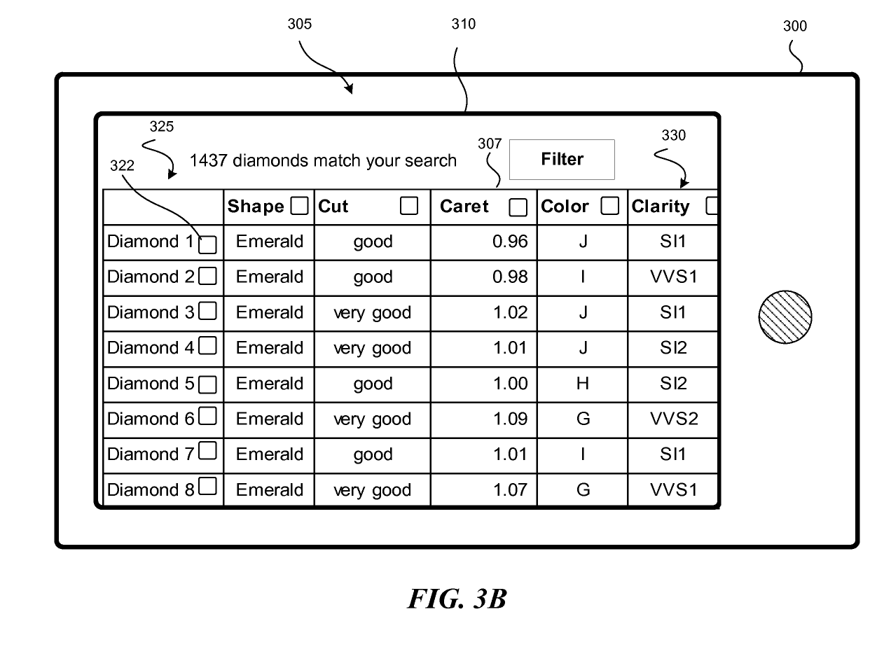

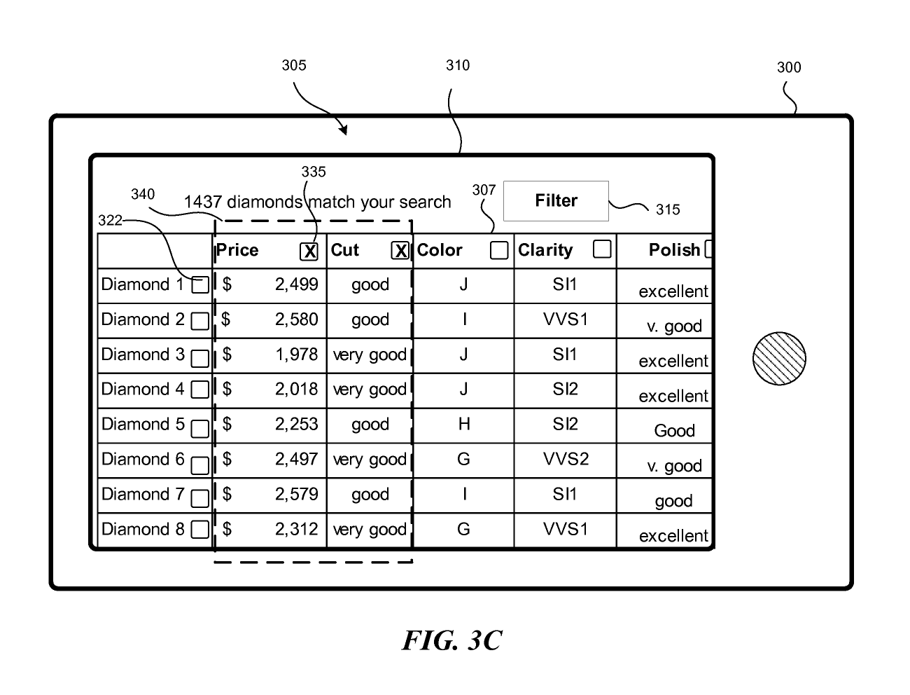

FIG. 3A is a schematic diagram illustrating an interface 305 that is generated for a display 310 (e.g., a touchscreen display) of a mobile device 300 (e.g., a tablet computer) in accordance with embodiments of the present technology. The interface 305 may be generated by the system under a variety of circumstances. For example, the interface 305 may be generated in response to a search query that is submitted by the user of the mobile device 300, it may be generated as a means to allow a user to browse a number of unique items maintained by a store or service, it may be generated by selection of pre-configured filters, etc. In the depicted example, the interface 305 is generated as a result of an initial search query for diamonds that was submitted by the user. The top of the display 310 indicates that “1437 diamonds” match the criteria specified by the user. Those criteria, which aren't depicted in the figure, can be viewed by selection of a “filter” button 315. After selecting the filter button 315, the user can adjust various parameters of the search query in order to refine the depicted search results or perform a different search.

The interface 305 with the search results is presented in the form of a grid 307, with unique items displayed in each row of the grid, and attributes of the unique items displayed in columns of the grid. In the representative search results depicted in FIG. 3A, each displayed diamond is characterized by a number of different attributes, such as price, shape, cut, caret, clarity, etc. For example, one of the diamonds 320 has a price of $1,978, an emerald shape, a “very good” cut, a caret weight of 1.02, and a color of “J.” It will be appreciated that diamonds can be characterized by significantly more attributes, however, than can readily fit within the viewable area of the display 310. For example, a diamond may also be characterized by clarity, length/width ratio, polish, symmetry, girdle, etc. Moreover, many more diamonds may be found in the search results than the number of diamonds that can be displayed on the display 310. To overcome these limitations, a user is allowed to scroll both horizontally in the grid 307 as well as vertically within the grid 307. A horizontal scroll, such as a leftward swipe across the interface 305 by the user, causes additional attributes to be displayed on the grid 307. FIG. 3B depicts the interface 305, for example, after the user has scrolled to the right on the grid 307 (such as, for example, by entering a leftward swipe across the display 310 or manipulating an interface element which controls scrolling). The first column 325 of the gird 307 has remained fixed, meaning that it remains in the same place on the display 310 and continues to identify the diamonds (diamond 1, diamond 2, . . . diamond 8) that were responsive to the search query. The “price” column, however, has been removed from the left side of the grid 307, and on the right side of the grid 307 a “clarity” column 330 is now visible to the user. Continued scrolling by the user will cause additional attribute columns to become visible to the user. If the user continues to scroll to the right, additional columns will be removed from the left side of the grid 307 (shape, cut, etc.) and additional columns will be added to the right side of grid 307 (width, depth, etc.). In a similar fashion, if the user scrolls back to the left, recently-removed columns will be re-introduced on the left side of the grid 307 and recently-displayed columns on the right side of the grid 307 will be removed. In this fashion, the user can scroll back and forth to see all attributes associated with the particular unique items being displayed.

While left-and-right horizontal scrolling have been discussed with respect to the depicted interface 305 in FIGS. 3A and 3B, it will be appreciated that up-and-down vertical scrolling may also be supported by the interface 305. As the user scrolls down on the grid 307, additional unique items (e.g., diamond 9, diamond 10, and diamond 11) will be displayed on the bottom of the grid 307. To make room for the additional unique items, unique items at the top of the interface 305 (e.g., diamond 1, diamond 2, and diamond 3) may be removed. In this fashion, a user may scroll up-and-down to see all unique items that are responsive to the search query.

One of the shortcomings in allowing a user to scroll within the interface 305 in this fashion, however, is that a user will sometimes want to compare material that has scrolled off the display 310 with material that remains on the display 310. In order to allow such comparison, a user is allowed to designate a fixed region on the grid 307 that is not subject to scrolling. In FIG. 3A, a number of controls 322 are provided to allow a user to designate the fixed region. By selecting one of the controls 322, the user indicates to the system generating the interface 305 that the user would like the corresponding attribute or unique item to remain fixed in the grid 307, regardless of any scrolling performed by the user. For example, selecting the control associated with row 320 indicates to the system that the user would like to maintain the unique item called “diamond 3” in the displayed grid. FIG. 3C depicts the interface 305 if the user has indicated using the controls 322 that the “price” column and the “cut” column should remain fixed. Selecting the controls 322 cause the system to display a graphical element 335 (an “X” in the example of FIG. 3C) on the controls 322 to reflect the selection. Moreover, by selecting the controls 322, the user has defined a region 340 that is to remain fixed on the grid 307 as the user scrolls horizontally. In this fashion, a user can easily compare the price and cut of certain diamonds, while also viewing the clarity and polish of those items at the same time. In a similar fashion, a user could also select one of the controls 322 associated with a row in the displayed grid 307 in order to fix one or more of the displayed unique items. For example, the user could fix diamonds 1 and 2 so that they could more readily be compared with diamonds 9 and 10. By allowing a user to selectively fix regions in the grid 307, the disclosed system significantly improves the user's ability to quickly assess the displayed unique items. In some embodiments, the region 340 can be determined based on other parties such as a recommendation from the owner of the dataset or a website or application's default setting.

As will be described in additional detail herein, the initial size of the displayed grid 307 is determined based on the size and the resolution (or other properties) of the display 310. In other embodiments, the size of the displayed grid 307 can be determined based on user preference. In some embodiments, the size of the displayed grid 307 may be impacted by the application in which it is implemented. For example, a mobile device application can be designed to display search results on an upper portion of a display and to display advertisements on a lower portion of the display. In such case, the grid 307 may be limited to the upper portion of the display in order to reserve room for the display of the advertisements.

While diamonds are displayed in the interface 305, it will be appreciated that other unique items are equally suitable for display in the grid 307. For example, the grid interface is equally useful for the display of gemstones, used automobiles, rare coins, art work, etc. By allowing a user to select both which unique items and which attributes to compare, a user may more quickly arrive at a purchase decision.

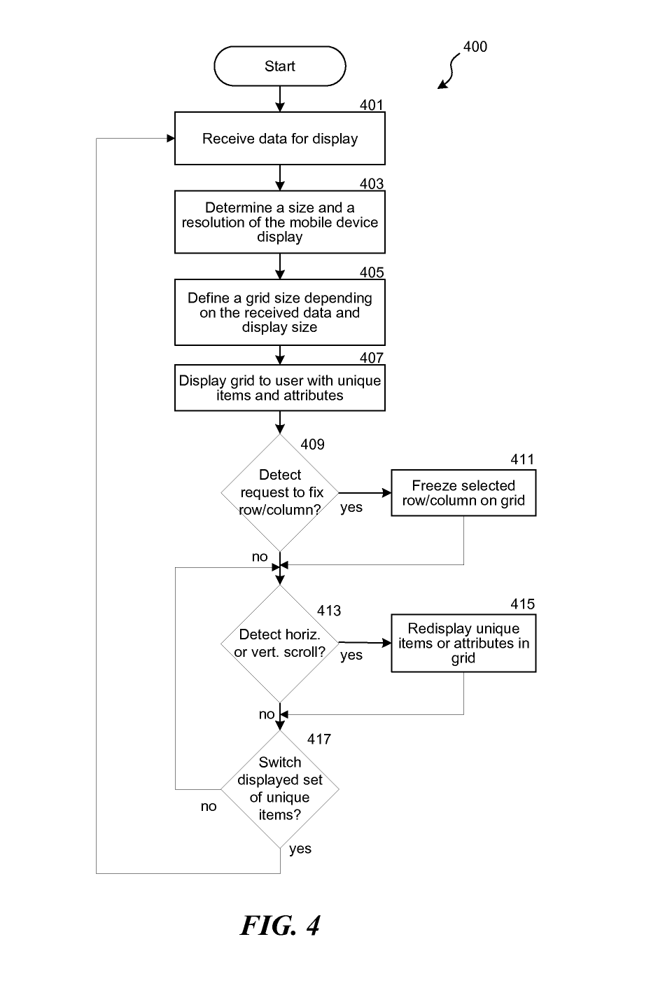

FIG. 4 is a flowchart illustrating a method 400 for generating an interface for the display of unique items. Depending on various needs, the method 400 can be implemented by any suitable systems (e.g., the mobile device 100 or the server computer 201 discussed above) to generate an interface to allow a mobile device user to review a large number of unique items (e.g., gemstones). Advantages of performing the method 400 by a mobile device (i.e., “locally” performed) include: (1) enabling mobile device users to quickly choose various forms (e.g., by designating fixed regions) to view a large number of unique items without requiring further network connection (e.g., a user can download a result of a search query, save it locally, and review it in various forms later); (2) easy access to display parameters (e.g., size and resolution); and (3) enabling mobile device users to store their preferences locally (e.g., which attributes to compare in a default setting). Advantages of performing the method 400 by a server computer (i.e., “remotely” performed) include (1) enabling a server administrator to track down mobile device users' activities of viewing search results (which can be further used for consumer behavior analyses); and (2) allowing a server administrator to provide recommendations regarding how to view unique items (e.g., a recommendation to set the price column as an initial fixed region, based on a prior consumer behavior analysis showing that the price attribute is the most important factor for a certain group of consumers).

The method 400 starts at a block 401 by receiving a set of unique items for display. The set of unique items can be generated in response to a search query. Alternatively, the set of unique items may reflect all or portions of a catalog that has been sorted by category, subcategory, or other factor. Each unique item has associated attributes that characterize the unique item. For example, for unique items that are gemstones the characterizing attributes might correspond to a price, a shape, a cut, a color, clarity, a weight, a stock number, a polish condition, a symmetry condition, a depth percentage, a table percentage, a girdle description, a culet description, a fluorescence condition, measurements, a unit price, and/or a length/width ratio of a gemstone. For other unique items, such as artwork, used automobiles, antiques, etc., the attributes would correspond to the different attributes that a user might be interested in when comparing the unique items with each other. For example, the size, condition, color, age, composition, etc., of the unique items may all be characteristics that a potential consumer may be interested in viewing.

At block 403, the method 400 determines the size and resolution of the mobile device display on which the unique items are to be displayed. To determine the size and resolution of the mobile device display, the system may query the mobile device, may access stored information about the characteristics of the mobile device, or may receive information provided by the mobile device. Displays of mobile devices have relatively small sizes comparing to those of non-mobile devices. To ensure that mobile device users can read or visually recognize the data shown on the display, the resolution and size of the display should be taken into account when displaying data thereon. For example, in some embodiments, to be recognizable, an interface may present data entries in an 8×6 grid format. In other embodiments, the interface may have different grids with different dimensions, such as 4×3, 6×6, 10×10, etc.

At a block 405, the system determines the size of the grid that can be displayed on the mobile device display. Several factors are used to determine the size of the grid. First, the system selects a desired font size for display on the mobile device. Font sizes that are too small are difficult for a user to see, whereas font sizes that are too large make poor use of the display area. Second, the system may assess the display size necessary to display the values associated with each attribute. Some attributes may require only a small amount of display space since the attribute value has limited characters, whereas other attributes may require a larger amount of display space since the attributes values have a large number of characters. As a simple example, an attribute having values of “Y” or “N” will generally need less space than an attribute that lists colors such as “orange,” “yellow,” or “turquoise.” Third, the system may assess an importance of the displayed attribute. For example, most consumers expect a “price” attribute to be displayed in search results but may have less concern about whether a “weight” attribute is initially displayed in the search results. The system may thus opt to include some attributes in an initial display while omitting other attributes. Other factors may also be taken into account by the system. Based on one or more of these factors, the system selects a grid size (N×M) to use for the particular mobile device. For example, for a smartphone the system may determine that the display area supports a 3×5 grid to display unique items. In contrast, for a tablet computer the system may determine that the display area supports an 8×10 grid to display unique items.

At a block 407, the system displays the selected grid size to the user. The grid is populated with data reflecting certain unique items and certain attributes of those unique items.

At a decision block 409, the system determines whether the user has elected to fix any of the columns and/or rows of the selected grid. As was previously described with respect to FIGS. 3A-3C, a user is allowed to identify one or more columns or rows that the user would like to see fixed on the screen. In this fashion, the user can more readily compare two different unique items or different attributes of unique items. At decision block 409, the system determines if any selection of a fixed region has been made by the user. If no selection has been made, processing continues to a decision block 413. If a selection of one or more rows or columns of the grid are received at decision block 409, however, processing continues to a block 411. At block 411, the system flags the selected rows and/or columns as being fixed. When indicated as fixed, the system will allow adjacent rows and/or columns to scroll, but will keep the selected rows and/or columns on a fixed position on the screen. Processing then continues to a decision block 413.

At decision block 413, the system determines whether a user has entered a scrolling command associated with the displayed grid. As was previously described, a user may scroll along one axis to view additional unique items, and may scroll along the other axis to view additional attributes associated with the displayed unique items. In some embodiments, a horizontal scroll, such as a leftward swipe across the interface by the user, causes additional attributes to be displayed on the grid. In contrast, a vertical scroll, such as an upward swipe across the interface by the user, causes additional unique items to be displayed on the grid. If a scrolling command is received by the system at decision block 413, at a block 415 the system displays different unique items or different attributes, as appropriate. As part of displaying the different unique items or attributes, the system takes into account any columns and/or rows in the grid that are fixed by the user. As was described with respect to FIGS. 3A-3C, a fixed region means that the columns or rows will be selectively updated by the system.

If no vertical or horizontal scroll was detected by the system in decision bloc 413, or if a scroll was detected but the displayed data in the grid was updated at block 415, processing continues to a decision block 417. At decision block 417, the system determines whether the user is to view a different data set of unique items. A different set of unique items might be displayed to a user if, for example, the user enters a new search query, if the system determines that the composition of available items has changed due to sale or withdrawal, if the user selects a different catalog or sub-catalog of unique items to view, etc. If a different set of unique items is to be displayed to the user, processing returns to block 401 where the system receives a new data set and the method 400 repeats. If the same set of unique items is to be displayed to the user, processing returns to block 413 where the system waits to receive a horizontal or vertical scrolling command.

While the description above describes the entry of a scrolling action by the user as being a swipe in one direction or another, it will be appreciated that there exist many different potential commands that could be entered by the user to indication a scrolling motion to the system. For example, the user may use a mouse, trackpad, trackball, or other device to enter the command. As another example, the system may include a voice interface that allows a user to merely speak a command like “scroll up” or “scroll left” to effectuate scrolling. As yet another example, the interface may contain a scrollbar on the display that may be used to enter the command. One skilled in the art will recognize that many other equivalent commands might be used to instruct the system to scroll the displayed grid.

In some embodiments, it will be appreciated that the system may provide an interface to allow a user to customize the displayed grid. For example, the user may be allowed to specify a font type, font size, number of initial rows or columns, type of initial rows or columns, and size of initial rows and columns in the displayed grid. Such user-entered configuration parameters may overrule any system-set configuration parameters when the interface grid is first shown to a user.

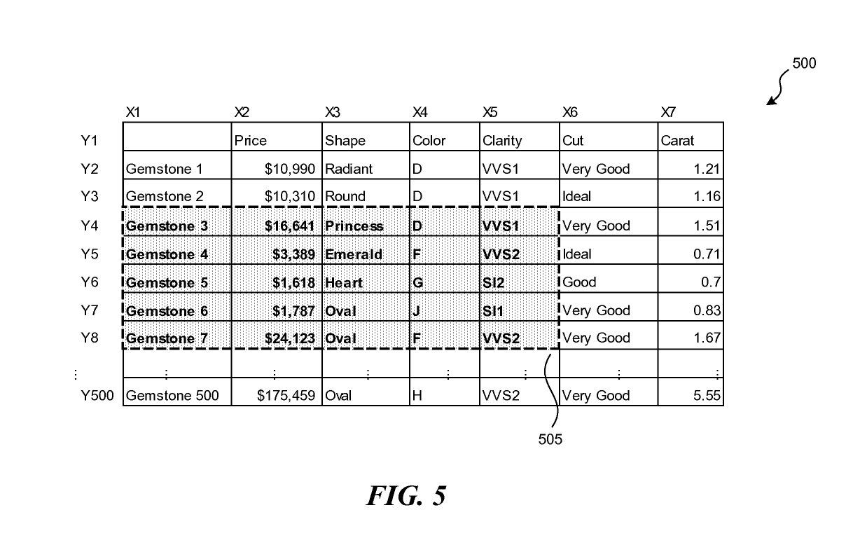

FIG. 5 is a schematic diagram illustrating a representative set of unique item data 500 that might be received by the disclosed system. As shown in FIG. 5, the dataset 500 includes 500 unique items, namely gemstones 1-500. Multiple attributes of each gemstone are shown along the X axis, and each of the unique gemstones is shown along the Y axis. It will be appreciated, of course, that the axes may be flipped with gemstones shown along the X axis and attributes along Y axis. In the illustrated embodiment, the dataset 500 is much larger than can be displayed on a mobile device display at one time. As such, the system must select a subset of the gemstones and attributes to initially display to a user. Using the method described in FIG. 5, the system may select a subset of the data that is appropriate for the size of the device display on which it will be shown. For example, the region 505 outlined by the dashed line in FIG. 5 may reflect the subset of the data that is initially chosen by the system to be displayed in a grid interface of a mobile device (see, e.g., FIGS. 3A-3C). If a user desires to see other portions of the data, the user may scroll within the displayed grid. In this fashion, should the user so choose they can ultimately view all of the gemstones and all of the attributes. Of course, most users prefer not to view such a large dataset and will instead use the comparison feature enabled by the disclosed technology to more quickly hone in on those unique items in which they are most interested.

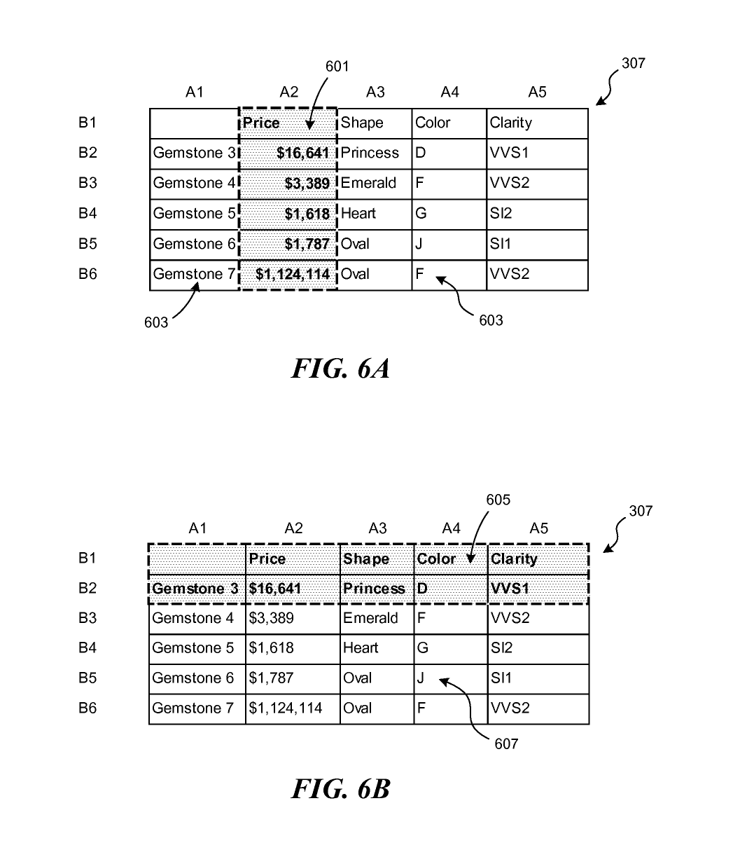

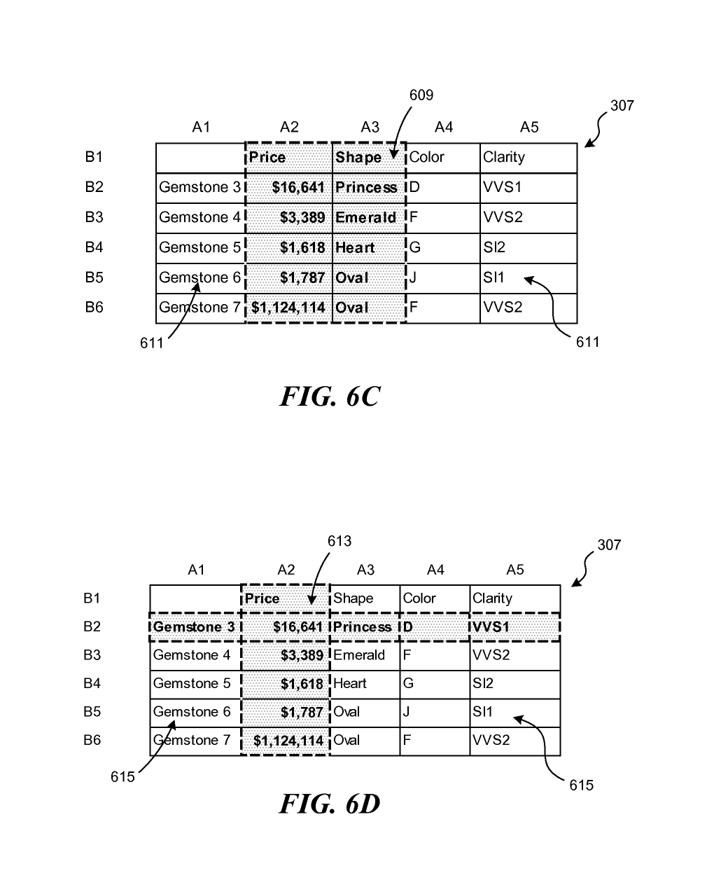

FIGS. 6A-6D are schematic diagrams illustrating additional examples of fixed regions and scrolling regions that might be implemented by the disclosed system. In FIG. 6A, the displayed grid 307 has been divided into a fixed region 601 and a scrolling region 603. In the illustrated embodiment, the fixed region 601 is a single column (i.e., column A2, or the price of gemstones) of the displayed grid 307. The fixed region 601 can be determined based on the mobile device user's selection of that attribute to be fixed. In other embodiments, the fixed region 601 can be determined based on other parties such as a recommendation from the owner of the dataset or a website or application's default setting. The data entries in the fixed region 601 are constantly displayed until the mobile device user chooses to stop (for example, by choosing a new fixed region or un-selecting the current fixed region). By doing so, the disclosed system allows a mobile device user to easily compare various gemstones with his/her choice of attribute always available. Ultimately, such an interface allows mobile device users to make purchase decisions more efficiently.

In the example shown in FIG. 6B, a fixed region 605 includes two rows (rows B1 and B2) of the displayed grid 307. In the depicted example, the mobile device user can easily compare a candidate gemstone (e.g., Gemstone 3) shown in the fixed region 605 with other gemstones shown in an adjacent scrolling region 607.

In the example shown in FIG. 6C, a fixed region 609 includes two columns (columns A2 and A3). In this example, the mobile device user has selected two attributes, i.e., Price and Shape, to be constantly displayed in the displayed grid 307. The data in a surrounding scrolling region 611 will then change as the user scrolls horizontally or vertically within the grid. While the two columns are depicted as being adjacent to one another in the figure, it will be appreciated that the chosen fixed columns can be separated. For example, a mobile device user may instead elect to fix column A2 and column A5.

Turning to the example shown in FIG. 6D, a fixed region 613 in this embodiment includes both a row (row B2) and a column (column A2). The data in a surrounding scrolling region 615 will then change as the user scrolls horizontally or vertically within the grid 307. By choosing to “fix” both a candidate gemstone (e.g., Gemstone 3) and a selected attribute (e.g., Price), a mobile device user can freely browse other “unfixed” data entries in the scrolling region 603, while always having the candidate gemstone and the selected attribute available for comparison. Such an interface is advantageous to allow mobile device users to efficiently make purchase decisions. In some embodiments, a user can partially “fix” a row when the user scrolls horizontally within the grid 307. For example, a user can choose to partially “fix” row B2 (i.e., fix blocks Al B2) and wholly “fix” the price column (column A2) when the user scrolls horizontally within the grid 307 (namely blocks A1B2, A2B1, A2B2, A2B3, A2B4, A2B5, and A2B6 are fixed when the user scrolls horizontally). By doing so, the user can still view the attributes of Gemstone 3 shown in the scrolling region (e.g., blocks A3B2, A4B2, and A5B2) when the user scrolls horizontally. In this example, when a user scrolls vertically, the partially-fixed row B2 is treated as a wholly-fixed row, which means the content displayed therein remains unchanged.

In general, the detailed description of embodiments of the present technology is not intended to be exhaustive or to limit the present technology to the precise form disclosed above. While specific embodiments of, and examples for, the present technology are described above for illustrative purposes, various equivalent modifications are possible within the scope of the present technology, as those skilled in the relevant art will recognize. For example, while processes (or steps) or blocks are presented in a given order, alternative embodiments can perform routines having steps, or employ systems having blocks, in a different order, and some processes or blocks can be deleted, moved, added, subdivided, combined, and/or modified. Each of these processes or blocks may be implemented in a variety of different ways. Also, while processes or blocks are at times shown as being performed in series, these processes or blocks may instead be performed in parallel, or can be performed at different times.

The teachings of the present technology provided herein can be applied to other systems, not necessarily the system described herein. For example, while the various embodiments are described above with respect to display of search results of gemstones, those embodiments can be implemented for display search results of other unique items such as used cars, art, as well as other less unique items, such as consumer electronics, clothing/shoes, etc. The elements and acts of the various embodiments described herein can be combined to provide further embodiments.

These and other changes can be made to the present technology in light of the above Detailed Description. While the above description describes certain embodiments of the present technology and describes the best mode contemplated, no matter how detailed the above appears in text, the present technology can be practiced in many ways. Details of the system can vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the present technology encompasses not only the disclosed embodiments, but also all equivalent ways of practicing or implementing the present technology under the claims.

While certain aspects of the present technology are presented below in certain claim forms, the applicants contemplate the various aspects of the present technology in any number of claim forms. For example, while only one aspect of the present technology is recited as embodied in a computer-readable medium, other aspects can likewise be embodied in a computer-readable medium

I/We claim:

1. A computer-implemented method of generating an interface to enable a mobile device user to assess a plurality of unique items on a mobile device, the computer-implemented method comprising:
receiving a dataset describing a plurality of unique items, each of the plurality of unique items having a plurality of attributes that characterize the corresponding unique item;
determining a size and a resolution of a display of a mobile device on which unique items are to be displayed;
determining a first number of the plurality of unique items that are to be presented on the display based on the size and the resolution of the display;
determining a second number of the plurality of attributes of the unique items that are to be presented on the display based on the size and the resolution of the display;
displaying, in a grid, the first number of unique items and the second number of attributes for each of the unique items;
receiving a designation of a fixed region of the displayed grid; and
in response to receiving a scrolling command from the mobile device user:
maintaining the fixed region of the grid on the display of the mobile device; and
selectively presenting additional portions of the dataset in the remainder of the grid that is not within the fixed region.

2. The computer-implemented method of claim 1, further comprising determining the first number and the second number based on a value length for each of the attributes.

3. The computer-implemented method of claim 1, wherein the unique items are gemstones and wherein the attributes are selected from a group consisting of a price, a shape, a cut, a color, clarity, a weight, a stock number, a polish condition, a symmetry condition, a depth percentage, a table percentage, a girdle description, a culet description, a fluorescence condition, measurements, a unit price, or a length/width ratio.

4. The computer-implemented method of claim 1, wherein the fixed region is one or more rows within the grid or one or more columns within the grid.

5. The computer-implemented method of claim 1, wherein the fixed region is defined by the mobile device user.

6. The computer-implemented method of claim 1, wherein the fixed region is defined by a party associated with the received dataset.

7. The computer-implemented method of claim 1, wherein the scrolling command is a horizontal or vertical action received on a touchscreen of the mobile device.

8. A computer-implemented method of generating an interface to enable a mobile device user to assess a plurality of gemstones, the computer-implemented method comprising:
receiving a dataset describing a plurality of gemstones, each of the plurality of gemstones having a plurality of attributes that characterize the corresponding gemstone;
determining a size and a resolution of a display of a mobile device on which gemstones are to be displayed;
determining a first number of the plurality of gemstones that are to be presented on the display based on the size and the resolution of the display;
determining a second number of the plurality of attributes of the gemstones that are to be presented on the display based on the size and the resolution of the display;
displaying, in a grid, the first number of gemstones and the second number of attributes for each of the gemstones;
dividing the displayed grid into a fixed region and a scrolling region;
in response to receiving a scrolling command from the mobile device user:
maintaining the fixed region of the grid on the display of the mobile device; and
selectively presenting additional portions of the dataset in the remainder of the grid that is not within the fixed region.

9. The computer-implemented method of claim 8, further comprising determining the first number and the second number based on a value length for each of the attributes.

10. The computer-implemented method of claim 8, wherein the attributes are selected from a group consisting of a price, a shape, a cut, a color, clarity, a weight, a stock number, a polish condition, a symmetry condition, a depth percentage, a table percentage, a girdle description, a culet description, a fluorescence condition, measurements, a unit price, or a length/width ratio.

11. The computer-implemented method of claim 8, wherein the fixed region is one or more rows within the grid or one or more columns within the grid.

12. The computer-implemented method of claim 8, wherein the fixed region is defined by the mobile device user.

13. The computer-implemented method of claim 8, wherein the fixed region is defined by a party associated with the received dataset.

14. The computer-implemented method of claim 8, wherein the scrolling command is a horizontal or vertical action received on a touchscreen of the mobile device.

15. A non-transitory computer-readable storage medium encoded with instructions that, when executed by a processor, cause the processor to implement a method of assessing a dataset representing a plurality of gemstones, the method comprising:
formatting a received dataset into a grid, the grid having a first data dimension and a second data dimension, the first data dimension corresponding to a plurality of available gemstones, the second data dimension corresponding to a set of attributes that characterize the plurality of available gemstones;
partially displaying the grid on a display of a mobile device;
receiving a designation of a fixed region and a scrolling region of the displayed grid; and
in response to receiving a scrolling indication from a user:
constantly displaying the same gemstones or attribute values in the fixed region of the grid; and
selectively displaying different gemstones or attribute values in the scrolling region of the grid.

16. The method of claim 15, wherein the attributes are selected from a group consisting of a price, a shape, a cut, a color, clarity, a weight, a stock number, a polish condition, a symmetry condition, a depth percentage, a table percentage, a girdle description, a culet description, a fluorescence condition, measurements, a unit price, or a length/width ratio of a gemstone.

17. The method of claim 15, wherein the fixed region includes a column of the displayed grid.

18. The method of claim 15, wherein the fixed region includes a row of the displayed grid.

19. A system for generating an interface to enable a mobile device user to assess a plurality of unique items, the system comprising:
a data storage component configured to store a grid of unique items, each of the unique items characterized by two or more attributes;
a display component coupled to the data storage component, the display component configured to:
determine a size and a resolution of a display of a mobile device;
at least partially display the grid in the display, the amount of the grid being dependent on the size and the resolution of the mobile device display;
receive a user input designating a fixed region and a scrolling region in the displayed grid; and
in response to receiving a scrolling indication from a user:
constantly display a first portion of the grid in the fixed region; and
selectively display a second portion of the grid in the scrolling region.

20. The system of claim 19, further comprising an input component to receive an instruction regarding the user action.

21. The system of claim 19, wherein the fixed region includes a column of the displayed grid.

22. The system of claim 19, wherein the fixed region includes a row of the displayed grid.
